(19) United States
(12) Patent Application Publication
(10) Pub. No.: US 2007/0014997 A1
(43) Pub. Date: Jan. 18, 2007

(54) Tool and method of making and using the same

(75) Inventor: Haiyan Zhang, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/181,150

(22) Filed: Jul. 14, 2005

(51) Int. Cl. B32B 13/04

(52) U.S. Cl. 428/446; 428/141; 428/143

(57) ABSTRACT

A method of making a tool comprises forming a copper layer consisting of discrete copper nodules. At least 80 percent of the nodules have a maximum width in a range of from 100 nanometers to 1 micrometer, and the layer is essentially free of platelet structures. The method may be used to make a tool having an endless textured surface. The tools are useful for making textured articles.

### BACKGROUND

Electrodeposition of metals has been widely used in electroplating, electroforming, and electrorefining. Typically, metallic ions are reduced on a cathode to form a crystallized metal layer.

For years, industrial efforts have been directed toward obtaining compact, smooth, and/or bright metal depositions. Toward these goals, it has been found that excessive current density during electrodeposition is undesirable. In this condition, the overpotential is so negative that the current density is close to, or even larger than, the limiting current density. At the limiting current density, electrodeposition is controlled by mass transport and the reaction rate reaches a constant maximum value. Further, increasing the current density beyond the limiting current density generally does not increase the electrodeposition rate, but instead increases the rates of side reactions such as, for example, hydrogen reduction.

### SUMMARY

In one aspect, the present invention provides a method for making a tool comprising:

providing a substrate having a metallic surface;

providing a copper electroplating solution;

contacting at least a portion of the metallic surface with the electroplating solution;

electrodepositing a copper layer on at least a portion of the metallic surface; and

terminating the electrodepositing step at a point such that the copper layer consists of discrete copper nodules, wherein at least 80 percent of the nodules have a maximum width in a range of from 100 nanometers to 1 micrometer, and wherein the continuous layer is essentially free of platelet structures.

Tools prepared according to the method of the present invention are useful, for example, for making articles having a textured surface.

Accordingly, in another aspect, the present invention provides a tool having an endless textured surface, wherein the textured surface comprises a continuous copper layer consisting of discrete copper nodules, wherein at least 80 percent of the nodules have a maximum width in a range of from 100 nanometers to 1 micrometer, and wherein the continuous layer is essentially free of platelet structures.

In yet another aspect, the present invention provides a method of making a textured article, the method comprising:

contacting a flowable material with at least a portion of a textured surface of a tool, wherein the textured surface comprises a copper layer consisting of discrete copper nodules, wherein at least 80 percent of the nodules have a maximum width in a range of from 100 nanometers to 1 micrometer, and wherein the continuous layer is essentially free of platelet structures; and

separating a textured article from the tool, the article having a surface comprising an inverse image of at least a portion of the textured surface of the tool.

Methods according to the present invention are useful, for example, for making articles having a textured surface with a nanometer-scale surface texture, which may affect adhesive and wetting properties of the workpiece. The methods are relatively simple, inexpensive, and in some embodiments suited for large-scale production.

As used herein the terms:

“discrete” as applied to copper nodules means having a readily identifiable boundary if viewed from a point taken normal to the textured surface;

“endless textured surface” means a textured surface that is endless with respect to an axis of rotation that is generally parallel to the surface;

“essentially free of” means containing less than one percent of on a numerical basis;

“flowable” means fluid or convertible to fluid by melting;

“platelet” means a minute plate; and

“platelet structure” means a discrete structure that has a least one platelet.

### BRIEF DESCRIPTION OF THE DRAWING

FIG. 1 is a perspective schematic drawing of an exemplary tool according to the present invention.

FIGS. 2a - 2c are scanning electron micrographs of textured surfaces produced by electrodeposition of copper onto a brass plate. FIG. 2b is a scanning electron micrograph of a textured surface suitable for use in tools and methods according to the present invention.

FIG. 3 is a scanning electron micrograph of an exemplary embossed film according to the present invention.

FIG. 4 is a scanning electron micrograph of the textured surface between adjacent ribs of FIG. 3.

### DETAILED DESCRIPTION

The present invention lies in the discovery that certain electroplated copper surfaces are useful for manufacturing article with surfaces having nanometer-sized features. The electroplated surfaces are prepared using an overpotential to generate structured surfaces in a controllable way.

The rate of electrodeposition depends, among other things, on the composition and concentration of the electroplating solution, time, the chemical nature of the substrate being electroplated, and the current density. Typically, some differentiation in the exact shape of the nodules may be observed, for example, depending on the exact conditions chosen or depending on the specific composition of the substrate.

Accordingly, in order to determine current density and time for a given substrate and electroplating solution that are suitable to generate a tool according to the present invention, a Hull cell electroplating procedure may be used. In this procedure, a plate of substrate material is mounted in a Hull cell filled with the electroplating solution such that at least a portion of the plate is immersed in the electroplating solution. Current (e.g., 1, 2, 3, or 5 amps) is applied until the immersed portion of plate has a polished copper finish on the end with lowest current density (region 1), and a dark brownish-blackish finish on the end with highest density (region 2). Under typical conditions this may accomplished in 30 seconds to 5 minutes, although longer and shorter times may be used. Generally, using this technique, conditions which will generate structured surfaces comprising a copper layer consisting of discrete copper nodules, wherein at least 80 percent of the nodules have a maximum width in a range of from 100 nanometers to 1 micrometer, and wherein the continuous layer is essentially free of platelet structures can be found in the transitional region between regions 1 and 2, which is generally characterized by a brownish-grayish appearance. Within this region, analysis by electron microscopy can readily determine the conditions which generate structured surfaces comprising a copper layer consisting of discrete copper nodules, wherein at least 80 percent of the nodules have a maximum width in a range of from 100 nanometers to 1 micrometer, and wherein the continuous layer is essentially free of platelet structures.

Hull cells and procedures for their use are well known. For example, Hull cells and ancillary gauges and procedures for use may be commercially obtained from Kocour Company, Chicago, Ill.

Once suitable electroplating conditions are known, those conditions are used to electroplate copper onto a substrate having a metallic surface. The metallic surface is typically an outer surface, more typically an outer major surface, which is typically continuous and/or endless (e.g., a roll, sleeve, or belt), although this is not a requirement. Examples of suitable substrates include plates, rolls, sleeves, and belts having a metallic surface. The metallic surface may be, for example, a layer of metal bonded to a metallic or non-metallic body (e.g., as in the case of a belt), or simply a surface of a metallic substrate (e.g., a in the case of a metal roll). Examples of suitable metals include copper, nickel, brass, and steel.

The copper plating solution used in this invention can be any solution so long as it can plate copper electrolytically. Examples include solutions containing one or more of copper sulfate, copper cyanide, copper alkanesulfonate and copper pyrophosphate, but other solutions may also be used. Matters such as the composition and ingredients of other plating solutions can be decided easily by persons skilled in the art from the following description of a copper sulfate plating solution and from published sources such as, for example, R. Pinner in Copper and Copper Alloy Plating, Second Edition: Copper Development Association, London, © 1964. Copper electroplating solutions are also widely available from commercial vendors.

Generally, the copper layer is deposited on the metallic surface of the substrate by at least partially, typically at least substantially completely, immersing the metallic surface in the copper electroplating solution, while applying a relatively negative potential to the metallic surface (i.e., configured as the cathode in an electrolytic cell). An anode having a relatively higher potential (e.g., a positive potential) and immersed in the copper electroplating solution and an external power supply complete the electrical circuit.

Electroplating is terminated when the desired copper electroplating conditions are achieved, for example, as determined using a Hull cell as described hereinabove. Upon termination, the substrate is typically rinsed to remove electroplating solution resulting in a tool having a copper layer that consists of discrete copper nodules, wherein at least 80 percent of the nodules have a maximum width in a range of from 100 nanometers to 1 micrometer, and wherein the continuous layer is essentially free of platelet structures. In some embodiments, at least 90 percent of the nodules have a maximum width in a range of from 100 nanometers to 1 micrometer.

In some embodiments, at least 80, 90, or even 95 percent of the nodules have a maximum width in a range of from 100 or 150 nanometers to 750 nanometers.

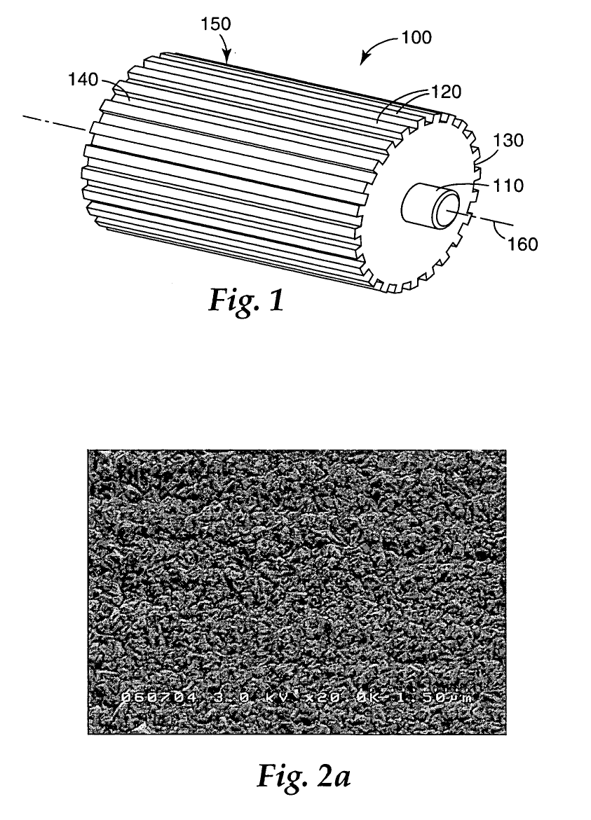

Referring now to FIG. 1, tool 100 has cylindrical roll 150 with two mounting rods 110 (one rod is not shown) outwardly extending from cylindrical roll 150 along major axis 160. Continuous surface 130 of tool 100 has ribs 120. Structured surface 140 is disposed between adjacent ribs 120.

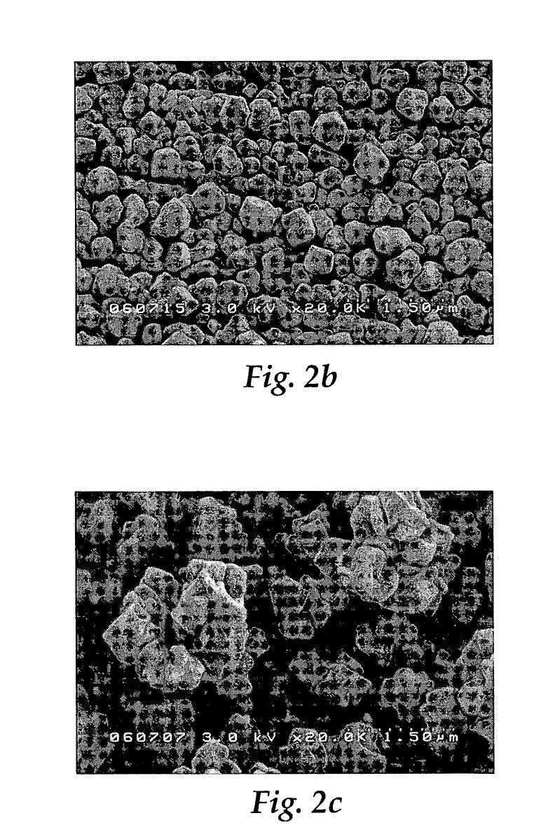

One exemplary textured surface is prepared in Example 1 (hereinbelow), and is shown in FIG. 2b.

Generally, surfaces corresponding to FIG. 2a (prepared in Example 1) may not generate porous features in textured articles (e.g., thermoplastic polymer films, extrusion cast polymer films) made according to the present invention, for example, as discussed hereinbelow, while surfaces corresponding to FIG. 2c (prepared in Example 1) may not release from textured articles made according to the present invention from the tool.

In some embodiments, the copper layer is at least partially covered with a conformal metal coating. This may be desirable as a way to harden the surface of the tool. Typically, in those embodiments, the metal coating is substantially uniform in thickness, and has an average thickness of from 5 to 500 nanometers. Examples of metals that may be deposited include nickel and chromium. Exemplary techniques for depositing the metal include metal vapor coating, sputtering, and chemical vapor deposition.

In some embodiments, a recessed pattern may be created on a surface of the continuous tool such that it extends through the copper layer and into the substrate. The pattern may have any shape. In one embodiment, the pattern comprises a plurality of straight channels (e.g., parallel or intersecting straight channels). For example, forming articles using such a tool according to the present invention results in articles having ribs that may serve to protect smaller embossed features from damage during handling.

Optionally, one or more mold release agents may be bonded to the tool to facilitate it use. Examples include silicones and fluorochemicals (e.g., fluorinated benzotriazoles as described in U.S. Pat. No. 6,376,065 (Korba et al.), the disclosure of which is incorporated herein by reference.

The tool may have any shape such as for example, a shape suitable for embossing, melt extrusion, or solvent casting; for example, a plate, roll, sleeve, or belt.

Tools according to the present invention are useful, for example, for making textured articles from a malleable or fluid material by contacting it with at least a portion of the textured surface of a tool according to the present invention.

In one embodiment, textured articles are produced by an embossing process in which a thermoplastic polymer film is brought into contact with the textured surface of the tool. Sufficient heat and pressure (e.g., as supplied by a heater and/or a press or nip roll) are provided such that an inverse pattern of at least a portion of the textured surface is embossed into a surface of the thermoplastic polymer film, which is then separated from the tool with the inverse pattern remaining intact on a surface of the thermoplastic polymer film. Examples of suitable workpieces include thermoplastic or elastomeric polymer articles such as films, tapes, labels, and discs. Examples of suitable malleable materials for this embodiment include thermoplastic polymers (e.g., polypropylene, polyethylene, polyurethanes, polyamides, and polyesters), and elastomers (e.g., styrene-butadiene elastomers and polyurethane elastomers). Determination of the exact conditions for a given workpiece is generally a simple matter of routine experimentation.

In another embodiment, textured articles are produced by contacting a fluid material with at least a portion of the textured surface of the tool. The fluid material is then solidified, for example, by cooling (e.g., in the case of a molten thermoplastic fluid), evaporation of solvent (e.g., in the case of solvent-borne fluid materials) and/or by curing (e.g., in the case of thermosettable fluid materials), and then separated from the tool to form a textured article with the inverse pattern remaining intact on a surface of the textured article. Examples of suitable fluid materials for this embodiment include molten thermoplastic polymers (e.g., molten polypropylenes, polyethylenes, polyurethanes, polyamides, cellulose esters, and polyesters), thermosettable resins (e.g., radiation curable acrylate and methacrylate resins, epoxy resins, and curable silicone elastomers), and solvent-borne polymers (e.g., cellulose esters and ethylene-vinyl acetates).

Objects and advantages of this invention are further illustrated by the following non-limiting examples, but the particular materials and amounts thereof recited in these examples, as well as other conditions and, details, should not be construed to unduly limit this invention.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

Hull Cell Screening

A 267 ml Hull cell obtained from Kocour Company, Chicago, Ill. was partially filled with a solution of that contained: copper sulfate (50 grams per liter), sulfuric acid (80 grams per liter), and polyethylene oxide (2 grams per liter). The cell was operated at a temperature of 22 ° C. A brass panel 7.5 cm ×10.0 cm was partially submerged in the Hull cell and subjected to a current of 2 amperes for 1 minute. The plated panel had a current density distribution ranging from less than 1 ampere/foot² (11 amperes/meter²) at one end to more than 80 amperes/foot² (860 amperes/meter²) at the opposing end. After plating, the panel was cut into small pieces for analysis by scanning electron microscopy. FIG. 2a shows the plated copper surface where the current density was 4 amperes/foot² (43 amperes/meter²), FIG. 2b shows the plated copper surface where the current density was 24 amperes/foot² (260 amperes/meter²), and FIG. 2c shows the plated copper surface where the current density was 80 amperes/foot² (860 amperes/meter²).

### Example 1

A copper-plated steel roll, diameter of 15.2 centimeters and face length of 25.4 centimeters, was precision machined to get a smooth surface with a roughness Rₐ of less than 100 nm. The roll was sprayed with Petroleum Naphtha (obtained from Brenntag Great Lakes Company, St. Paul, Minn.) for one minute, followed by spraying with acetone for one minute. The plate was rinsed with water and then sprayed with isopropanol. After the surface was blown dry with compressed air, the roll was plated in a bath composed of: 50 grams/liter of copper sulfate, 80 grams/liter of sulfuric acid, and 2 grams/liter of polyethylene oxide. A current of 54 amperes was applied for 0.5 minutes at 19 ° C. and the roll was rotated at a rate of 7 revolutions per minute (rpm). The roll was rinsed with deionized water and dried by compressed air. A uniform surface structure was formed. After this structure was obtained, the roll was machined by a diamond tool to cut channels on the surface with the following size: top width of the channel was 55 micrometers, bottom width 23 micrometers wide, and height 170 micrometers. The pitch of the channel was 214 micrometers.

The roll was then sprayed with Petroleum Naphtha obtained from Brenntag Great Lakes Company, St. Paul, Minn., for one minute, followed by spraying with acetone for one minute. The plate was rinsed with water and then sprayed with isopropanol. After the surface was blown dry with compressed air, the roll was dipped into a cleaning tank, which was composed of 60 grams/liter of a metal cleaner obtained under the trade designation “METAL CLEANER 373” from Atotech USA, Inc., Rock Hill, S.C. The solution temperature was 65.6 ° C. Anodic cleaning was conducted with a current of 23.5 amperes for 1minute. The roll was taken out of the tank and rinsed with deionized water, followed by spraying with 2% sulfuric acid. The roll was rinse with deionized water again and put into an electroless nickel bath. The bath was composed of electroless nickel plating solutions obtained under the trade designations “AUTONIC MXPA” (100 milliliter/liter), and “AUTONIC LNS” (50 milliliter/liter), both from Stapleton Technologies, Long Beach, Calif. The temperature of the bath was 87° C. The roll was used as the cathode while a current of 15.6 amperes was applied for 20 seconds. The resultant nickel-plated roll was then rinsed by deionized water and dried with compressed air.

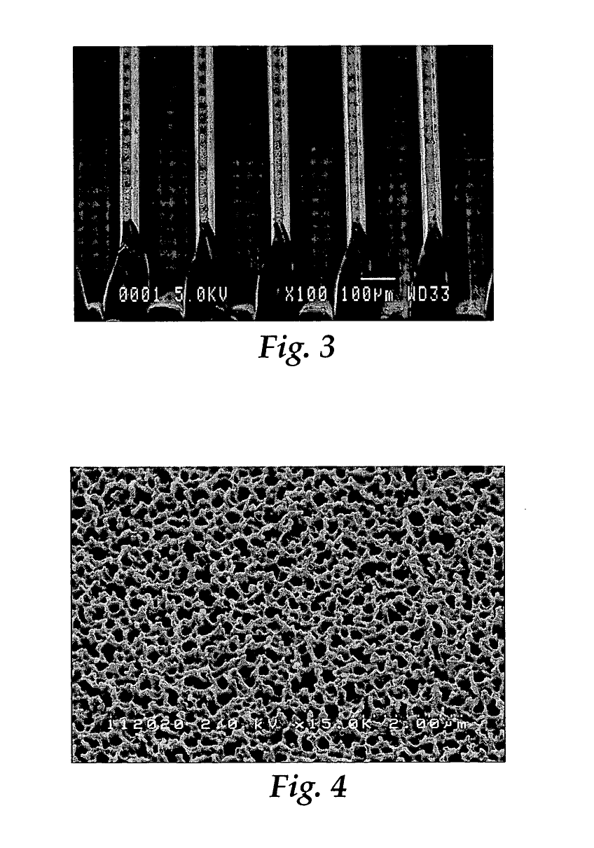

The roll was then installed, together with a stainless steel nip roll, on a RCP 1.0 extruder made by Randcastle Extrusion System, Inc., Cedar Grove, N.J. and equipped with a flexible lip die. The temperature of the three adjustable heating zones of the extruder were set at 232° C. and the extrusion die temperature was set at 243° C. The rotation rate of the roll was 7 rpm. The top cooling flow rate was set at 10 to 20 gallons per minute (gpm, 38 to 76 liters/minute) and lower cooling flow rate at about 25 gpm (95 liters/minute). Polypropylene obtained under the trade designation “POLYPROPYLENE 3155” from Exxon Chemical, Houston, Tex. was extruded onto the roll to generate a structured polymeric film. Photomicrographs of surface structures of the structured polymeric film are shown in FIGS. 3 and 4. FIG. 4 is a higher magnification view of the surface between adjacent ribs visible in FIG. 3.

Various modifications and alterations of this invention may be made by those skilled in the art without departing from the scope and spirit of this invention, and it should be understood that this invention is not to be unduly limited to the illustrative embodiments set forth herein.

What is claimed is:

1. A method of making a tool comprising:
providing a substrate having a metallic surface;
providing a copper electroplating solution;
contacting at least a portion of the metallic surface with the electroplating solution;
electrodepositing a copper layer on at least a portion of the metallic surface; and
terminating the electrodepositing step at a point such that the copper layer consists of discrete copper nodules, wherein at least 80 percent of the nodules have a maximum width in a range of from 100 nanometers to 1 micrometer, and wherein the continuous layer is essentially free of platelet structures.

2. A method according to claim 1, wherein at least 90 percent of the nodules have a maximum width in a range of from 100 nanometers to 750 nanometers.

3. A method according to claim 1, wherein at least 95 percent of the nodules have a maximum width in a range of from 100 nanometers to 750 nanometers.

4. A method according to claim 1, wherein the surface is a continuous surface.

5. A method according to claim 1, further comprising creating a recessed pattern on a surface of the continuous tool that extends through the copper layer and into the substrate.

6. A method according to claim 5, wherein the pattern comprises a plurality of straight channels.

7. A method according to claim 1, further comprising depositing a uniform conformal metal coating on at least the copper layer, wherein the metal coating has an average thickness of from 5 to 500 nanometers.

8. A tool having an endless textured surface, wherein the textured surface comprises a continuous copper layer consisting of discrete copper nodules, wherein at least 80 percent of the nodules have a maximum width in a range of from 100 nanometers to 1 micrometer, and wherein the continuous layer is essentially free of platelet structures.

9. A tool according to claim 8, wherein at least 90 percent of the nodules have a maximum width in a range of from 100 nanometers to 750 nanometers.

10. A tool according to claim 8, wherein at least 95 percent of the nodules have a maximum width in a range of from 100 nanometers to 750 nanometers.

11. A tool according to claim 8, wherein the textured surface is a continuous surface.

12. A tool according to claim 8, wherein the textured surface comprises a plurality of recessed features that inwardly extend through the monolayer and into the tool.

13. A tool according to claim 12, wherein the recessed features comprise straight channels.

14. A tool according to claim 8, further comprising a uniform conformal coating of metal on the copper layer, wherein the coating of metal has and average thickness of from 5 to 500 nanometers.

15. A method of making a textured article, the method comprising:
contacting a flowable material with at least a portion of a textured surface of a tool, wherein the textured surface comprises a copper layer consisting of discrete copper nodules, wherein at least 80 percent of the nodules have a maximum width in a range of from 100 nanometers to 1 micrometer, and wherein the continuous layer is essentially free of platelet structures; and
separating a textured article from the tool, the article having a surface comprising an inverse image of at least a portion of the textured surface of the tool.

16. A method according to claim 15, wherein at least 90 percent of the nodules have a maximum width in a range of from 100 nanometers to 750 nanometers.

17. A method according to claim 15, further comprising creating a recessed pattern on a surface of the continuous tool that extends through the copper layer and into the substrate.

18. A method according to claim 17, wherein the recessed pattern comprises a plurality of straight channels.

19. A method according to claim 15, wherein the flowable material comprises a thermoplastic polymer or a thermosettable material.

20. A method according to claim 15, wherein the flowable material comprises a molten thermoplastic polymer.

21. A method according to claim 15, wherein the textured surface further comprises a uniform conformal coating of metal on the copper layer, wherein the coating of metal has and average thickness of from 5 to 500 nanometers.

22. A textured article, prepared according to claim 15.
